(19) United States
(12) Patent Application Publication
(10) Pub. No.: US 2011/0241453 A1
(43) Pub. Date: Oct. 6, 2011

(54) ELECTRICAL MACHINE AND METHOD FOR THE MANUFACTURE OF STATOR SECTIONS THEREFOR

(75) Inventors: Fredrik IDLAND, Trondheim (NO); Rune Morten HAUG, Trondheim (NO); Sigurd OVREBO, Levanger (NO)

(73) Assignees: SMARTMOTOR AS, Trondheim (NO); ROLLS-ROYCE MARINE AS, Ulsteinvik (NO)

(21) Appl. No.: 13/091,738

(22) Filed: Apr. 21, 2011

Related U.S. Application Data
(63) Continuation-in-part of application No. PCT/NO2009/000382, filed on Nov. 4, 2009.

(30) Foreign Application Priority Data
Nov. 12, 2008 (NO) 2008 4775

(51) Int. Cl. H02K 3/30; H02K 3/24; B29C 67/00; B29C 70/68; B29C 67/24; B29C 71/00

(52) U.S. Cl. 310/43; 310/59; 264/69; 264/101

(57) ABSTRACT

Electrical machine with a rotor with magnets carried by an annular carrier, in which a magnetic field is created over an air gap between two rotor parts, at which an ironless stator with windings is arranged. A space saving machine is achieved with a stator which is assembled of sections with channels for circulation of coolant, and which has windings with an annular, compact central part providing the active part of the stator. A method for manufacturing stator sections for such electrical machines is described, where a winding is embedded in an electrically insulating casting material for providing a rigid element. A coil is arranged in one part of a bisected shell housing or a bisected casting mold, and the shell housing or mould is closed, casting material is introduced through an opening and the inner part of the housing or mould is subject to underpressure and possibly vibration.

This application is a continuation-in-part of PCT/NO2009/000382 filed Nov. 4, 2009, the contents of which are incorporated herein by reference.

### BACKGROUND OF THE INVENTION

The invention relates to an electrical machine, and a method for the manufacturing of stator sections for such a machine.

The electrical machine concerned has a rotor with magnets on an annular carrier for creating a magnetic field over an air gap wherein an ironless stator with windings is arranged.

It may be electrical motors or electrical generators or combined machines which may be operated both as generator and as motor and which may have an axial or a radial field.

The method relates to a process wherein a winding is embedded in an electric insulating casting material for creating a rigid element.

The stator of electrical machines traditionally had windings with an iron yoke, normally sheet metal. In most types of electrical machines, the windings are placed in a groove to create a magnetic field in the iron around the winding. This kind of stator is used both in radial flux and axial flux machines.

In machines with permanent magnets and bilateral rotor with axial magnetic field, axial flux machine, it is common to use a torroide wound stator wherein the windings are arranged around an iron core without teeth. One of the advantages of such a machine is that the reluctance is independent of the position of the rotor, to avoid cogging.

In PM machines with bilateral rotor where the north and south of the magnets are facing each other, the iron may be omitted from the stator. The magnet field then will yield from one rotor and axially or radially to the second rotor part. Such a two poled machine is described in U.S. Pat. No. 1,947,269 issued 1934. The machine described has two dish shaped permanent magnets with diametrical magnetizing arranged with facing opposed poles to have the magnetic field axcially directed in the air gap. By arranging windings in said magnetic air gap, an ironless stator is created.

One advantage of the ironless stator is the elimination of iron losses normally created in the stator. The windings are arranged in the air gap, without any iron with a varying magnetic field creating hysterese losses and eddy current losses. Another advantage when the size of the machine increases is the almost complete elimination of the forces between the rotor and the stator. In conventional PM machines with iron in the stator, the force trying to pull the rotor against the stator is typically highly exceeding the torque created. In radial machines, this creates no problem when the rotor is centrally located, because the forces are distributed. When the rotor leaves the central position, the problem will emerge, particularly for larger machines. This also applies to axial machines with iron in the stator and bilateral rotor, while machines with single sided rotor will have no equalizing of forces.

A machine with ironless stator is described in the paper by Spooner E et al “Lightweight ironless-stator PM generators for direct-drive wind turbines” IEE Proc-Electr. Power App. Vol. 152, No 1, pp 17-26, January 2005. The machine described is a radial flux machine with only one rotor. Since the stator is ironless and permanent magnets are only located at one side, the flux going through the stator windings would be lower than in the solutions with two rotors.

A further machine with ironless stator is described in British patent specification 1491026 of 1975. The rotor of this machine has six permanent magnets on the surface of each rotor section. The stator comprises multiple coils with a plurality of windings placed in an even circular series with overlapping coils at the inner and outer diameter. The stator dish is thin in the area between the magnets and thicker at the inner and outer part. The windings are joined by an epoxy based casting material or similar.

A corresponding winding arrangement is described in EP Application 0058791 from 1981. The winding arrangement has an overlap at the inner and outer edge, where the stator is having a larger axial extent than in the active area between the magnets. The arrangement described is for a two phase machine, but a similar arrangement can be used for a three phase machine by a different connection as also state in the claim.

The same kind of windings arrangement is also described in EP Application 0633563 from 1989 and U.S. Pat. No. 5,744,896 from 1998. The winding arrangements described therein has a continuous structure and are therefore difficult to separate in smaller sections without implying extensive connecting work. At larger machines it is a great advantage to separated the machine in smaller part, both for manufacturing, transport and mounting.

A further different winding arrangement for an ironless stator is described in U.S. Pat. No. 4,334,160. One coil is plain and two coils are offset differently, to let the end windings overlap I three levels, while maintaining one layer in the active part of the winding. This arrangement also has a continuous structure making separation in sections difficult.

### Cooling

To cool machines with high current, multiple cooling proposals are known. In the publication XP000585921 by Caricchi and Crescimbini: “Prototype of an innovative wheel direct drive with water-cooled axial-flux PM motor for electric vehicle application” (APEC '96 Eleventh Annual Applied Power Electronics Conference and Exposition, San Jose, Mar. 3-7, 1996, a machine with integrated cooling is described wherein the coils are wound around a cooling tube of fiber reinforced epoxy. The design of the stator require the a one piece manufacturing, and the inlet and the outlet of the cooling water has to be arranged between the end windings.

### Sectioning

In U.S. Pat. No. 6,781,276 a radial flux machine is sectioned, with a IPS-4 module by using mutual encapsulating of each module/section. An encapsulation for the end windings as well as an outer encapsulation covering the segment totally is shown. The notion “fully enclosed and tight” is used to describe this in the claims. Such an enclosure introduce multiple disadvantages:
enclosures with complex geometry has to be provided to high costs
several sealing faces are encountered bringing sealing problems
a void is provided, with cyclical temperature changes which may create condensation.

### SUMMARY OF THE INVENTION

The main object of the invention is providing a cooled electrical machine in sections, which can be manufactured and installed more easily than prior art machines.

Further, it is an object to provide an electrical machine with a larger diameter than prior art machines, to increase the circumferential speed.

It is also an object to provide an electrical machine with a reduced weight power ratio.

Further it is an object to provide an electrical machine with a favorable air gap power ratio, to maintain high tolerances.

Still another object is providing an electrical machine, the stator sections being easy to mount and dismount.

Another object of the invention is to provide a method for manufacturing stator elements, which can be carried out effectively and with high and stable quality.

The invention is directed to an electrical machine which comprises a stator which is assembled of sections with channels for circulation of coolant, and with windings with an annular, compact central part providing the active part of the stator.

It is an advantage if the rotor carries permanent magnets. But the rotor may also be assembled of magnets comprising super conductors.

The invention may utilize different field directions, but the magnets are preferably providing an axial field.

It is preferred that each stator section is embedded in a casting material introduced into a casting mould or a shell housing accommodating the windings, said casting material providing the enclosure of the stator and provide channels for coolant.

Each stator section may comprise separate connections for inlet and outlet of coolant.

To allow removal of a stator arranged between two rotor parts, at least one part of the rotor is provided for insertion and removal of stator sections.

It is preferred that the winding comprises multiple identical trapezoid coils with an active part and an end winding, allowing the coils to be assembled with the active part in a common plane, with overlapping end windings in two or more planes.

At least a half side of a coil is omitted at each end of a section. The void of the omitted half side of a coil may be used as inlet or outlet for coolant to/from tangential cooling channels.

The magnets are preferably arranged on radially protruding jaws, said magnets being radially arranged dish segments in an annular assembly.

For a machine with Q=1 the number of phases, the number of pair of poles and the number of sections may be chosen as follows:

$${N}_{sections} = {k}_{1} \cdot {N}_{phases} , {k}_{1} ∈ N$$

$$\frac{{N}_{pole pairs} \cdot {N}_{phases}}{{N}_{sections}} = {k}_{2} , {k}_{2} ∈ N \backslash \{ {N}_{phases} \cdot m for m ∈ N \}$$

At a three phase machine three and three windings are overlapping, the end windings being distributed in three levels, while the three coils are arranged at the same level in the active region (between the magnets) and the number of coils and the number of pair of poles is calculated as:

N_{coils}=k₃·k₄·2·Nₚₕₐₛₑₛ², k₃·ε [symbol] , k₄ε

[symbol]

N_{pole pairs}=k₃·(2·Nₚₕₐₛₑₛ²·k₄−1), k₃·ε [symbol] , k₄·ε

[symbol]

The invention also comprises a method for manufacturing of stator sections for such electrical machines, wherein a winding is embedded in an electrically insulating casting material for providing a rigid element. The coils are arranged in one part of a bisected shell housing or a bisected casting mould, that the shell housing or mould is closed, and a casting material is introduced through an opening and the inner part of the housing or mould is subject to underpressure and possibly vibration.

The channels for coolant may be provided by covering external grooves on the stator enclosure.

When building large electrical machines it is a greater challenge to comply to rigid requirements for tolerances normally applied to electrical machines with permanent magnets and laminated stators. When the stator laminates are deleted to make the stator ironless and not magnetic. The requirements for the tolerances are substantially reduced. A movement of the rotor 2-3 millimetre relatively to the stator in a prior art PM machine will create unbalance in the forces between rotor and stator, and the voltage induced will be substantially different at different parts of the machine. With an ironless stator the voltage unbalance will be substantially reduced and there will be no unbalanced forces between rotor and stator, because the stator is not magnetic.

When the dimensions of the machines are large, it is an advantage to divide the both rotor and stator in smaller sections. Instead of tools for building a full size machine, only a set of smaller tools for building a section is needed, and this section can be mass produced for subsequent mounting in frames or another assembly.

Transport of such sections is substantially easier than transporting complete machine, particularly when the size exceeds maximum size for road transport. Another major advantage when building the machine in sections is less costs for maintenance. If an error occurs in one of the sections, this section may easily be replaced by a backup section to avoid long downtime.

To divide the stator in smaller sections and keeping the magnet fields effectively utilized, the winding structure has to be changed in relation to previous described concepts. This will be described further with reference to the following examples.

### BRIEF DESCRIPTION OF THE DRAWINGS

The invention will be described with reference to the drawings, wherein

FIG. 1 is a perspective view of a section of an electrical machine according to the invention, e.g. a wind mill generator, without cover and assembly elements,

FIG. 2 is a partly sectioned perspective view of stator section for a three phase electrical machine corresponding to the example in FIG. 1,

FIG. 3 is a side view of a coil section for the stator section in FIG. 2,

FIG. 4 is a sectioned end view of a stator section in FIG. 2,

FIG. 5 is a perspective view of an alternative winding unit for three phase connection, and

FIG. 6 is schematically the arrangement for mounting and removal of stator sections in an assembled electrical machine.

### DESCRIPTION OF THE PREFERRED EMBODIMENTS

In FIG. 1 a machine section 11 with two main parts is shown: a stator section 12 and a rotor section 13 both shown partly. The rotor section 13 may also be sectioned.

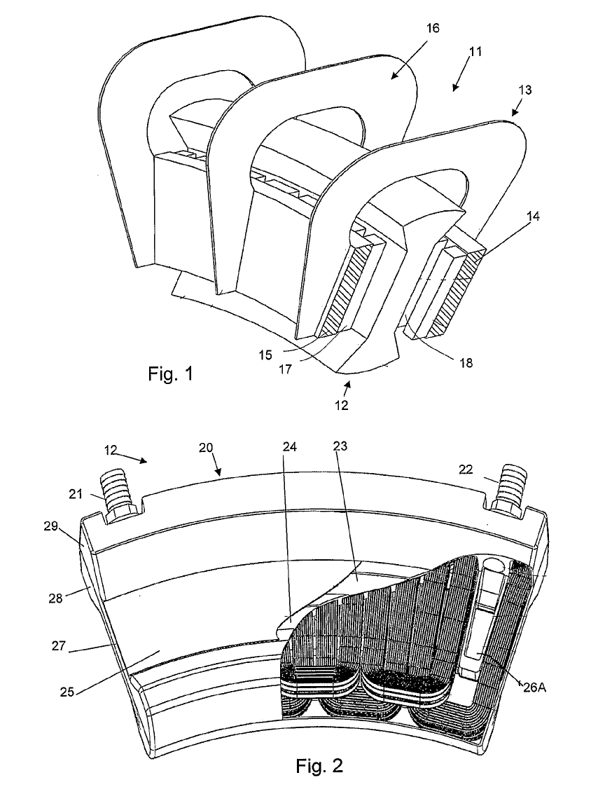

The stator section 12 is a part of an annular assembly of identical or corresponding sections being attached stationary to an engine base in a manner known per se. An example of a stator section 12 is shown with more details in FIG. 2.

The rotor 13 is correspondingly mounted in prior art manner to a shaft not shown, for driving or being driven by external equipment. A particularly interesting field of use is connected to wind turbines. The main purpose will be the generation of electric power, but the electrical generator can also be connected to act as a motor to create a braking torque. Another example is the use as steering machine for ships, demanding a motor with a high torque and with little space available.

The rotor 13 has two annular rotor yokes 14, 15 of magnetic iron conducting the flux between the magnets. The magnets may be of solid material with rectangular cross section and are fixed side by side by a series of U-jaws 16 of sheet material being connected on the outer side of the rotor yokes 14, 15, e.g. by welding.

On each rotor yoke 14, 15 a series of radially oriented sticks 17 of permanent magnetic material are attached. The PM-sticks 17 are arranged with interstices or gaps 18.

This is a preferred structure for certain purposes, e.g. for large diameter generators for windmills. For other purposes one may conceive designs where multiple stators are cooperating with a rotor assembly with multiple axial fields. A requirement for such multi dish machines is a rotor structure allowing access to install and remove the stator.

Further it is possible to adapt the concept with stator sections for radial machined, to move the rotor with two concentric series of permanent magnets.

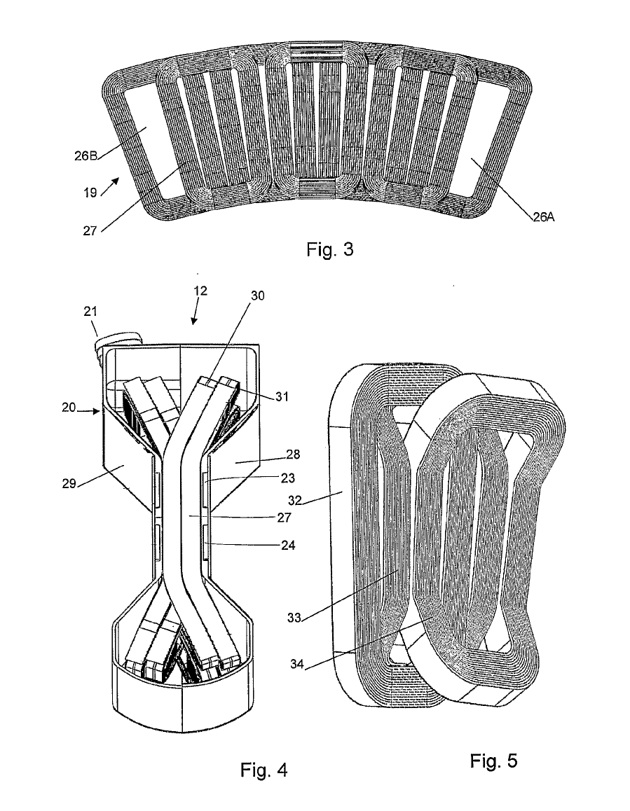

FIG. 2 shows a stator section 12 with details in FIGS. 3 and 4. The arrangement has three main parts: a winding 19, an enclosure 20 and a cooling system with an inlet 21 and an outlet 22.

The cooling system comprises a pair of channels 23, 24 provided by parallel grooves on the outside of the enclosure shells and covered by a sheet 25 being attached by gluing.

The winding 19 is shown more detailed in FIG. 3 and described in the following. By omitting a part of a coil at each end, an opening 26A, 26B is created at each end. The winding 19 may be prepared of a ribbon conductor, e.g. a cupper band, to provide a compact central part 27 suited for the gap between the rotor parts.

The winding 19 is enclosed in the enclosure 20 defined by two shells 28, 29 of plastics. Said shells provide 40 degree of an annular structure, and are generally symmetrically to a radial central plane. Said shells are arranged for accommodating the winding 19 in recesses. At each end of a shell 29 a pipe socket 21, 22 is arranged as inlet and outlet.

FIG. 4 shows a section of a stator before filling with casting material, with cover sheets providing the channels 23, 24. The heads 30, 31 of the windings are shown protruding out of the central plane.

At an alternative embodiment, the winding 19 is placed in a two part casting mould being closed during filling with casting material.

FIG. 5 shows an assembly of three coils 32, 33, 34 for a three phase winding. The stator may be symmetrical to the air gap of the rotor. The assembly to a complete stator may be as described above.

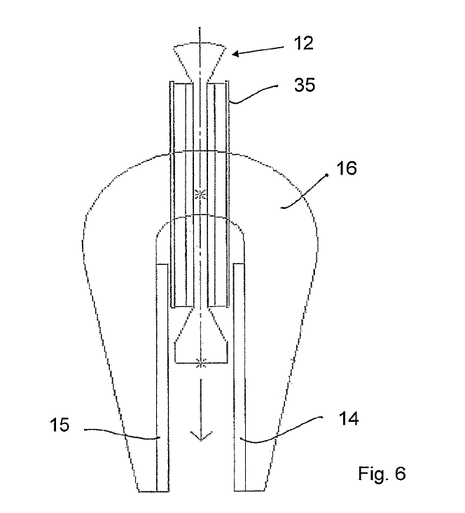

FIG. 6 shows schematically how a stator section 12 may be removed or installed in an electrical machine according to the invention, corresponding to the embodiment shown in FIG. 1, together with parts of the rotor 13. In this example, the distance between the parts of a jaw 16 is larger than the width of the stator sections.

In this example, a part of the permanent magnets 17, unfastened from the annular yoke 14, is removed together with the corresponding part of the stator. The permanent magnets 17 may e.g. be attached to sheets mounted on the annular yoke. This allows for stabilizing the magnetic forces during transport.

Alternatively, is a part of the rotor, which extends over a larger part of the circumference than a stator section, being removed, to make opening for installing and removal of stator sections. This will allow maintenance and repair of electrical machines according to the invention, even at large dimensions and on locations difficult to access, e.g. at a wind mill generator.

### Winding Arrangement, Alternative 1:

The winding arrangements in U.S. Pat. No. 5,744,896 and EP 0633563 are continuous and cannot be sectioned without separating a winding. At the invention, one coil per section is removed, and only one turn per phase is connected to the next section, and the coils have to be mutually connected throughout the machine. Each section will then have a vacant “track” at each end of the section. In a machine with one “track” per pole per phase (Q=1), the number of section has to be a multiple of number of phases, to make the number of coils equal for all phases (N_{sections}=k*phases, where k is an integer). Additionally, the number of poles has to be chosen to have the omitted coil part belong to different phases. For a machine with Q=1 the number of phases, the number of poles and the number of sections be chosen to comply to the equation:

$$\begin{matrix}{N}_{sections} = {k}_{1} \cdot {N}_{phases} , {k}_{1} ∈ N & ( 1 ) \\ \frac{{N}_{pole pairs} \cdot {N}_{phases}}{{N}_{sections}} = {k}_{2} , {k}_{2} ∈ N \backslash \{ {N}_{phases} \cdot m for m ∈ N \} & ( 2 )\end{matrix}$$

In a three phase machine complying to said equations, but having a different number of coils per phase in each section, the number of coils per phase will be uniform by connecting three and three sections serially. Said series of three sections may be connected serially or in parallel.

The heat emission in the stator is controlling the torque of the machine. Good cooling therefore is needed for utilizing the machine fully. The cupper of the ironless stator may be cooled by using the cooling channels 23, 24 on both sides of the winding. The cooling channels 23, 24 are arranged in the enclosure as will be described. The channels are extending tangentially on each side of the stator. The distance between the cooling channels and the cupper should be short and the intervening material should have a high thermal conductance.

As one coil is omitted from each section, two “tracks” will be available, one at each end of the section. This place can be used to introduce and extract coolant to and from each section. From this “track” the coolant can enter both sides of the stator through the tangential cooling channels. Additional parallel cooling channels may be arranged to cool the end windings.

An alternative cooling arrangement is to arrange the tangential cooling channels in the center of the stator sections instead of on each side. In this way the cross section of each cooling channel may be increased without increasing the axial extension of the stator section.

Another alternative is cooling the cupper direct, by using a tubular cupper conductor or a plastic tube included in a litz-wire. This will reduce the distance from the cupper to the coolant. The free “track” will not be needed, as there is no need for inlet and outlet of coolant. To utilize the free space and still avoid continuous windings according to prior art, a winding arrangement as described under Alternative 2 may be used.

### Windings Arrangement, Alternative 2

When cooling the cupper direct, an open groove as described in Alternative 1 is not desirable. Nevertheless, it should be possible to divide the machine in smaller sections. In a three phase machine, this may be realized by placing the coils to let three and three coils be a separate unit with the end windings be distributed don three levels, while the active region of the winding is at one level corresponding to the windings of Alternative 1. Such a unit with three coils is shown in FIG. 5. One of the three coils are even, while the remaining have folded ends. The folded are identical but one has the fold arranged with the opposite. Thus the end windings will overlap in three levels instead of two as described in Alternative 1.

The advantage of this unitary design of the windings is the possibility of partitioning in smaller sections wherein only one winding per phase has to be connected to the next section to have a continuous arrangement of windings, but also this arrangement has a restriction in the number of coils in each section. The reason for this is the mutual inductance between the coils, which will be different if the three coils are arranged consecutive in a complete circle with Q=1. The central coil in each unit is better magnetically connected to the other coils than the “end coils” are connected.

Thus each coil should cover more or preferably less than a pole step, to make Q≠1. The number of coils per section should be a multiple of three in a three phase machine, to make the sections consist of an integer number of “coil units”. When this requirement is fulfilled may the number of sections be chosen freely. The number of grooves per pole per phase (Q) should however be chosen to let each phase have an equal number of coils I each position. This is the case when the number of coils and the number of pair of poles is chosen according to the following equation:

N_{coils}=k₃·k₄·2·Nₚₕₐₛₑₛ², k₃·ε [symbol] , k₄·ε [symbol] (3)

N_{pole pairs}=k₃·(2·Nₚₕₐₛₑₛ²·k₄−1), k₃·ε [symbol] , k₄·ε [symbol] (4)

### Enclosure

The ironless stator elements of the present invention consist generally of cupper and casting material. Each stator element has the highest possible IP. Each section has an inlet and an outlet for a coolant, as well as electrical connection of each phase. As each stator section is embedded in casting material, there is no need for housing with complicated geometry and sealing to protect the windings and there are no voids with air. The invention thus eliminates a part of the problems of the sectioning described in U.S. Pat. No. 6,781,276.

The sections may have a fixture at the inner or outer circumference at an axial machine. The sections need the strength to transfer the forces created in the stator both as a result of the torque created and also of the weight of the section.

Another important quality is the thermal conductance. This should be high to conduct heat from the cupper windings. The thermal conductance is particularly important for the winding arrangement and the cooling system described in alternative 1, where in layer of casting material is arranged between the cupper and the cooling channel.

The finished sections should have least possible air bubbles. This is particularly important in applications for high voltage; to avoid small areas with different permittivity, which can give partial discharge. By using a casting material with the permittivity of air, the avoidance of air bubbles in the casting material will be less important.

### Maintenance

The need for simple maintenance is an important factor at building a machine with sectioned stator.

At the invention is the thickness of the stator section lowest in the area between the magnets and thicker at the inner and outer diameter. To have maximum flux, the magnets are arranged close to the stator on each side. The air gap between the magnets and the stator is governed by mechanical tolerances, but it is typically less than the difference between the lowest thickness of the stator and the thickness of the end windings. Thus it will not be possible to remove a stator section in radial direction when the rotor is installed. To replace a stator section, the rotor should be partly removed. By providing the rotor with two or more sections, this operation may be substantially simplified.

As the rotor can be placed in a desirable position, it is sufficient that one part of the rotor can be removed. This part should be some larger than a stator section, to be able to move the stator section axially. To simplify the manufacturing, the transport, and the mounting, may the rotor be sectioned similar to the stator, but either with fewer sections to make the rotor sections larger than the stator sections or by using two different rotor sections.

A problem at such removal is the large forces acting between the rotor parts on different sides of the stator. At large machines substantial forces are needed to remove one side of a rotor. This may be avoided by removing a complete part of the machine, i.e. a stator section together with a rotor section on each side thereof. Said rotor sections may be fixed together to maintain the mutual distance during removal. To remove a complete part of a machine, the rotor section on one side should be larger than the stator section, while the rotor section on the other side should be slightly smaller than the stator section. This design may be used both when the complete rotor is in sections, and when only two rotor parts may be removed.

By splitting the rotor in two or more parts, no high magnetic contact between the various parts will be possible in large machines. The reason is thermal expansions and the need for tolerances. The rotor should therefore be spitted in the center of a permanent magnet, as there will be no substantial flux across the yoke in this position.

A further alternative for installing/removal of stator and rotor sections is illustrated in FIG. 6, see the above description. In this case the stator sections are removed radially together with a corresponding rotor section on each side of the yoke. The rest of the rotor yoke is annular and carries the rotor sections.

### Examples of Use

The invention is generally suitable for applications demanding high torque and large diameter. Examples are direct driven wind mills and steering machines, both having low velocity, but demand for high torque. Further examples are generators for hydro power plants, tidal power plants, wave power plants, ship propulsion, winches, actuators and rock crushing plants.

What is claimed is:

1. Electrical machine with a rotor (13) with magnets (17) carried by an annular carrier (14, 15), at which a magnet field is created over an air gap between two rotor parts, at which an ironless stator (12) with windings (19) is arranged, wherein the stator is assembled of sections (12) with channels (23, 24) for circulation of coolant, and that it has windings with an annular, compact central part (27) providing the active part of the stator.

2. Electrical machine according to claim 1, wherein the rotor carries permanent magnets (17).

3. Electrical machine according to claim 1, wherein the rotor is designed with magnets comprising super conductors.

4. Electrical machine according to claim 1, wherein the magnets (17) are providing an axial field.

5. Electrical machine according to claim 1, wherein each stator section (12) is embedded in a casting material introduced into a casting mould or a shell housing (28, 29) accommodating the windings, said casting material providing the enclosure of the stator and provide channels (23, 24) for coolant.

6. Electrical machine according to claim 1, wherein each stator section (12) comprises separate connections for inlet and outlet of coolant.

7. Electrical machine according to claim 1, wherein at least one part of the rotor is provided for insertion and removal of stator sections.

8. Electrical machine according to claim 1, wherein the winding comprises multiple identical trapezoid coils with an active part and an end winding, allowing the coils to be assembled with the active part in a common plane, with overlapping end windings in two or more planes.

9. Electrical machine according to claim 1, wherein at least a half side of a coil is omitted at each end of a section.

10. Electrical machine according to claim 9, wherein the void (26A, 26B) of the omitted half side of a coil has inlet or outlet for coolant to/from tangential cooling channels (23, 24).

11. Electrical machine according to claim 4, wherein the magnets (17) are arranged on radially protruding jaws (16), said magnets being radially arranged dish segments in an annular assembly.

12. Electrical machine according to claim 1, wherein the number of sections and the number of pair of poles are governed by the equations:
$${N}_{sections} = {k}_{1} \cdot {N}_{phases} , {k}_{1} ∈ N$$
$$\frac{{N}_{pole pairs} \cdot {N}_{phases}}{{N}_{sections}} = {k}_{2} , {k}_{2} ∈ N \backslash \{ {N}_{phases} \cdot m for m ∈ N \}$$

13. Electrical machine according to claim 1, wherein the coils are overlapping to have the end windings distributed on a number of levels like the number of phases, while al coils are arranged in the active region (between the magnets) and the number of coils and pair of poles corresponds to the equations:
N_{coils}=k₃·k₄·2·Nₚₕₐₛₑₛ², k₃·ε [symbol] , k₄ε [symbol]
N_{pole pairs}=k₃·(2·Nₚₕₐₛₑₛ²·k₄−1), k₃·ε [symbol] , k₄·ε

[symbol]

14. Method for manufacturing of stator sections for electrical machines according to claim 1, comprising embedding a winding (19) in an electrically insulating casting material for providing a rigid element, wherein the winding (19) is arranged in one part of a bisected shell housing (28, 29) or a bisected casting mold, the shell housing or mold is closed, casting material is introduced through an opening and the inner part of the housing or mould is subject to underpressure and possibly vibration.

15. Method according to claim 14, wherein the channels for coolant are provided by covering external grooves on the stator enclosure.
